(19) United States
(12) Patent Application Publication
(10) Pub. No.: US 2014/0362598 A1
(43) Pub. Date: Dec. 11, 2014

(54) Traffic warning device

(71) Applicants: Lucien Racicot, Lac Brome (CA); Patrick Racicot, Lac Brome (CA)

(72) Inventors: Lucien Racicot, Lac Brome (CA); Patrick Racicot, Lac Brome (CA)

(21) Appl. No.: 14/291,953

(22) Filed: May 30, 2014

(30) Foreign Application Priority Data
Jun. 7, 2013 (GB) 1310264.5

(51) Int. Cl. B60Q 1/26

(52) U.S. Cl. CPC B60Q 1/2642
USPC 362/542

(57) ABSTRACT

A traffic warning device comprising: a base for mounting to a vehicle and defining base first and second ends; a deployable element mounted to the base and movable relative thereto between a parked position, a first deployed position and a second deployed position, wherein, in the parked position, the deployable element extends along the base and is substantially centered relative thereto, in the first deployed position, the deployable element is offset from the base and protrudes therefrom at the base first end, and, in the second deployed position, the deployable element is offset from the base and protrudes therefrom at the base second end. The deployable element is provided with visible traffic warning elements. The deployable element is deployable on opposite sides of the vehicles by being moved respectively to the first and second deployed positions.

### FIELD OF THE INVENTION

The present invention relates generally to safety and, more particularly, to a traffic warning device for a motor vehicle.

### BACKGROUND

Retractable traffic warning devices attachable to a vehicle are known in the art. Such devices typically include an arm or panel member having a proximal end portion pivotably attached to a side, rear or top portion of a vehicle. The pivotable member is manually or power operated by the driver between a retracted position, wherein the member is positioned such that it does not interfere with safety regulations or aerodynamic characteristics of the vehicle, and a deployed configuration, wherein the member is pivoted to a predetermined angle relative to the vehicle such that a generally elongated or wide side portion thereof is substantially visible by incoming drivers approaching the vehicle. The side portion of the member thus positioned in the field of view of these drivers is further generally provided with highly visible indicias or patterns of flashing lights to enhance the visibility of the extended member.

While these prior art devices can generally fulfill the main objective of providing some form of warning sign to incoming automobilists approaching a parked vehicle equipped with the device, they also entail one or more of the following disadvantages.

These traffic warning devices of the prior art generally offer a warning sign that is deployable on only one side of the vehicle or, otherwise, require a device on each side of the vehicle, which represent a relatively more expensive installation.

They are generally permanent installations on a vehicle, or at least do not represent devices that are relatively easily and rapidly removable from a vehicle for maintenance purposes or rapid transfer on another vehicle.

Against this background, there exists a need for an improved traffic warning device attachable for a vehicle. It is a general object of the present invention to provide such a device.

### SUMMARY OF THE INVENTION

In a broad aspect, the invention provides a traffic warning device for a vehicle, the vehicle defining opposite sides, the traffic warning device comprising: a substantially elongated base defining substantially longitudinally opposed base first and second ends, the base being mounted to the vehicle when the traffic warning device is in an operative configuration; and a substantially elongated deployable element mounted to the base and movable relative thereto between a parked position, a first deployed position and a second deployed position, wherein, in the parked position, the deployable element extends along the base and is substantially centered relative thereto, in the first deployed position, the deployable element is offset from the base and protrudes therefrom at the base first end, and, in the second deployed position, the deployable element is offset from the base and protrudes therefrom at the base second end. The deployable element is provided with visible traffic warning elements. The deployable element is deployable on the opposite sides of the vehicles by being moved respectively to the first and second deployed positions.

In some embodiments of the invention, the deployable element defines substantially longitudinally opposed deployable element first and second ends, the deployable element first and second ends being respectively substantially adjacent the base first and second ends in the parked position, the deployable element second end being in register with the base in the first deployed position and the deployable element first end being in register with the base in the second deployed position.

In some embodiments of the invention, the traffic warning device as further comprises an actuator operatively coupled to the base and to the deployable element for selectively moving the deployable element to the parked, first deployed and second deployed positions and a controller operatively coupled to the actuator for selectively activating the actuator to move the deployable element between the parked, first deployed and second deployed positions.

In some embodiments of the invention, the actuator is a linear actuator operatively coupled to the base and deployable element for substantially longitudinally moving the base and deployable element relative to each other between the parked, first deployed and second deployed positions.

In some embodiments of the invention, the vehicle includes a motor, drive wheels and a transmission provided therebetween, the transmission having power transmitting configurations in which power is transmitted from the motor to the drive wheels and at least one non-power transmitting configuration in which the drive wheels are uncoupled from the motor. In the operative configuration, the controller is operatively coupled to the transmission so as to prevent activation of the actuator to move the deployable element relative to the base when the transmission is in one of the power transmitting configurations. Furthermore, in some embodiments, the controller is configured for determining when the deployable element is in the parked position; and when in the operative configuration, the controller is operatively coupled to the transmission for preventing movement of the transmission from the non-power transmitting configuration to one of the power transmitting configuration unless the deployable element is determined to be in the parked position.

In some embodiments of the invention, the base includes an attachment removably attachable to the vehicle. For example, the attachment is attachable to a vehicle towing hitch.

In some embodiments of the invention, the visible traffic warning elements include light emitting elements. For example, the light emitting elements are longitudinally spaced apart along the deployable element and the traffic warning device is configured to activate the light emitting elements in a first predetermined sequence when the deployable element is in the deployable element first position and in a second predetermined sequence when the deployable element is in the deployable element second position. In a specific embodiment of the invention, in the first predetermined sequence, the light emitting elements are sequentially turned on in a first direction parallel to a first base direction leading from the base second end towards the base first end, and, in the second predetermined sequence, the light emitting elements are sequentially turned on in a second direction parallel to a second base direction leading from the base first end towards the base second end.

In some embodiments of the invention, the base includes a base main member and the deployable element has a substantially C-shaped transversal configuration. The base main member is at least partially nested in the deployable element. For example, the base main member has a substantially C-shaped transversal configuration and defines substantially opposed base end walls substantially adjacent the base first and second ends. The base main member and the deployable element together define an enclosure when the deployable element is in the parked position.

In other embodiments of the invention, the base includes a base main member and the deployable element is at least partially received in the base main member. For example, the base main member is substantially tubular.

In some embodiments of the invention, the deployable element defines substantially longitudinally opposed deployable element first and second ends and a deployable element center location midway therebetween. The deployable element is provided with a first and a second pair of wings pivotally mounted to the deployable element substantially adjacent respectively the deployable element first and second ends, the first and second pair of wings being each movable between a retracted configuration in which the wings from each of the pair of wings are substantially parallel to the deployable element and an extended configuration in which the wings within each of the pair of wings have a substantially V-shaped configuration protruding laterally outwardly from the deployable element and pointing away from the deployable element center location.

In some embodiments of the invention, the wings each define opposed wings proximal and distal ends and the wings are pivotally mounted to the deployable element substantially adjacent the wing proximal ends. The wings within each pair of wings are biased towards the extended configuration. In the parked position, the wings are all at least partially contained in the base main member and confined thereby to the retracted configuration with the wing distal ends further away from the deployable element center location than the pivot point. In the first and second deployed positions, the wings substantially adjacent respectively the deployable element first and second ends are in the extended configuration.

In another broad aspect, the invention provides a vehicle, the vehicle defining opposite sides, the vehicle comprising: a traffic warning device including a substantially elongated base defining substantially longitudinally opposed base first and second ends, the base being mounted to the vehicle; and a substantially elongated deployable element mounted to the base and movable relative thereto between a parked position, a first deployed position and a second deployed position, wherein, in the parked position, the deployable element extends along the base and is substantially centered relative thereto, in the first deployed position, the deployable element is offset from the base and protrudes therefrom at the base first end, and, in the second deployed position, the deployable element is offset from the base and protrudes therefrom at the base second end; the deployable element being provided with visible traffic warning elements; whereby the deployable element is deployable on the opposite sides of the vehicles by being moved respectively to the first and second deployed positions.

The features of the traffic warning device mentioned hereinabove also apply to the vehicle.

In addition, the various feature recited hereinabove can be combined together when suitable to do so.

Advantageously, the proposed traffic warning device is relatively inexpensive to manufacture while being convenient to use and relatively robust.

Other objects, advantages and features of the present invention will become more apparent upon reading of the following non-restrictive description of some embodiments thereof, given by way of example only with reference to the accompanying drawings.

### BRIEF DESCRIPTION OF THE DRAWINGS

FIG. 1, in a perspective view, illustrates a traffic warning device according to an embodiment of the present invention, the traffic warning device being removably attachable to a vehicle and shown here with a deployable element thereof in a retracted position;

FIG. 2, in a rear cross-sectional view, illustrates the traffic warning device of FIG. 1;

FIG. 3, in a side cross-sectional view, illustrates the traffic warning device of FIG. 1;

FIG. 4, in a side cross-sectional view, illustrates a traffic warning device according an alternate embodiment of the present invention;

FIG. 5, in an electrical schematic view, illustrates an exemplary embodiment of a controller usable for selectively operating the traffic warning devices of FIGS. 1 to 4;

FIG. 6, in a rear elevational view, illustrate the traffic warning device of FIGS. 1 to 3, here shown attached to the hitch of a police vehicle and in a parked position;

FIG. 7, in a rear elevational view, illustrate the traffic warning device of FIGS. 1 to 3 and 6, here shown attached to the hitch of a police vehicle and in a first, or leftward, deployed position;

FIG. 8, in a rear elevational view, illustrate the traffic warning device of FIGS. 1 to 3, 6 and 7, here shown attached to the hitch of a police vehicle and in a second, or rightward, deployed position;

FIG. 9, in a side cross-sectional view, illustrates the traffic warning device shown in FIGS. 1 to 3 and 6 to 8;

FIG. 10, in a side cross-sectional view, illustrates a traffic warning device according to another alternate embodiment of the present invention, which is permanently integrated to the rear end portion of the vehicle, as a replacement of the rear bumper thereof;

FIG. 11, in a top cross-sectional view, illustrates a traffic warning device according to yet another alternate embodiment of the present invention,

FIG. 12: in a side cross-sectional view, illustrates the traffic warning device of FIG. 11;

FIG. 13, in a partial rear cross-sectional view, illustrates a traffic warning device according to yet another alternate embodiment of a present invention, the traffic warning device including wings, the wings being here shown in a retracted configuration;

FIG. 14, in a partial rear cross-sectional view, illustrates the traffic warning device shown in FIG. 13 with the wings in a semi-retracted configuration; and

FIGS. 15, in a partial rear cross-sectional view, illustrates the traffic warning device shown in FIGS. 13 and 14 with the wings in an extended configuration.

### DETAILED DESCRIPTION

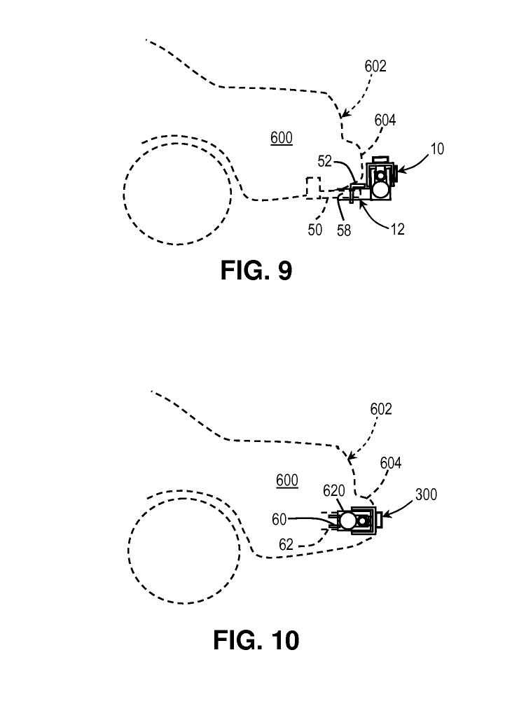

Referring to FIG. 9, there is shown a traffic warning device 10 in accordance with an embodiment of the present invention, here shown attached to a vehicle 600. The vehicle 600 generally defines opposite vehicle end portions 602, only one of which is shown in FIG. 9.

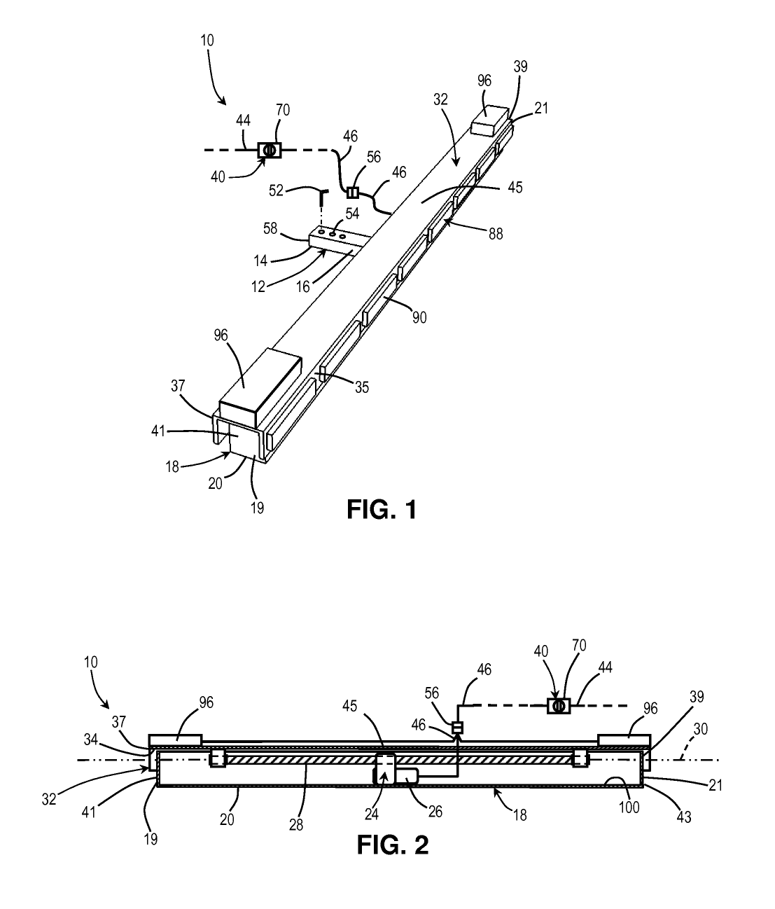

Referring to FIGS. 1 and 2, the traffic warning device 10 includes a substantially elongated base 18 and a substantially elongated deployable element 32 mounted to the base 18. The deployable element 32 defines substantially longitudinally opposed deployable element first and second ends 37 and 39 and a deployable element center location 45 midway therebetween. The deployable element 32 is provided with visible traffic warning elements, or indicias, 88, described in further details hereinbelow. The base 18 defines substantially longitudinally opposed base first and second ends 19 and 21. The base 18 is mounted to the vehicle 600 (not seen in FIG. 1) when the traffic warning device 10 is in an operative configuration.

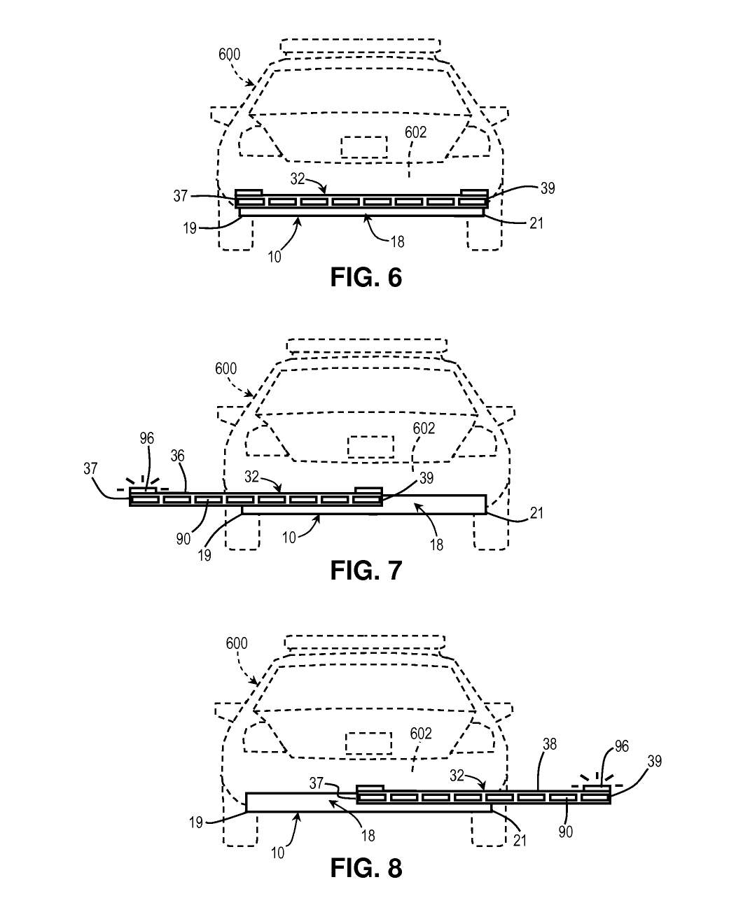

The deployable element 32 is movable relative to the base 18 between a parked position (seen in FIG. 6), a first deployed position (seen in FIG. 7) and a second deployed position (seen in FIG. 8). In the parked position, the deployable element 32 extends along the base 18 and is substantially centered relative thereto, in the first deployed position, the deployable element 32 is offset from the base 18 and protrudes therefrom at the base first end 19, and, in the second deployed position, the deployable element 32 is offset from the base 18 and protrudes therefrom at the base second end 21. The deployable element 32 is deployable on the opposite sides of the vehicle 600 by being moved respectively to the first and second deployed positions. Typically, the deployable element first and second ends 37 and 39 are respectively substantially adjacent the base first and second ends 19 and 21 in the parked position, the deployable element second end 39 is in register with the base 18 in the first deployed position and the deployable element first end 37 is in register with the base 18 in the second deployed position, as seen respectively in FIGS. 6, 7 and 8. However, other relationships between the base 18 and the deployable element 32 are possible in alternative embodiments of the invention.

In some embodiments of the invention, the base 18 includes an attachment 12 removably attachable to the vehicle 600. For example, the attachment 12 attachable to a vehicle towing hitch 50, as seen in FIG. 9. More specifically, the attachment 12 defines an attachment proximal portion 14 attachable to the vehicle end portion 602, and an opposed attachment distal portion 16 extending from a base main member 20. The attachment proximal portion defines a hitch adapter 58 lockingly engageable on the towing hitch 50 in a conventional manner using a locking pin 52 inserted in corresponding locking holes 54 (seen in FIG. 1 for example) provided through both the hitch adapter 58 and the towing hitch 50. Other conventional hitch attachment arrangements are also within the scope of the invention.

Typically, as seen for example in FIG. 2, the traffic warning device 10 further comprises an actuator 24 operatively coupled to the base 18 and to the deployable element 32 for selectively moving the deployable element 32 to the parked, first deployed and second deployed positions. A controller 40 is operatively coupled to the actuator 24 for selectively activating the actuator 24 to move the deployable element 32 between the parked, first deployed and second deployed positions.

For example, the actuator 24 is a linear actuator 24 operatively coupled to the base 18 and deployable element 32 for substantially longitudinally moving the base 18 and deployable element 32 relative to each other between the parked, first deployed and second deployed positions. To that effect, the linear actuator 24 includes an actuator drive unit 26 mounted to the base 18, and more specifically to a base main member 20 thereof, and an actuator movable member 28 mounted to the deployable element 32. The actuator movable member 28 is linearly movable relative to the actuator drive unit 26 along a movement axis 30, which is substantially longitudinally oriented relative to the base 18 and deployable element 32.

Now referring more particularly to FIGS. 1, 2 and 5, the controller 40 is described in further details. The controller 40 is electrically coupled to a conventional vehicle power source (not shown in the drawings) and to the linear actuator 24 through first and second multi-conductor electrical cable 44 and 46 respectively. The controller 40 allows a user to selectively operate the deployable element 32 such that the latter is moved between the parked, first deployed and second deployed positions.

In some embodiments, the traffic warning device 10 includes a manually detachable cable connector 56 inserted in the second electrical cable 46, between the controller 40 and the linear actuator 24. Furthermore, cable connector 56 is typically positioned substantially proximal the attachment 12. Thus, when the hitch adapter 58 is unlocked from the towing hitch 50 and the cable connector 56 is disconnected, the traffic warning device 10 may be removed from the vehicle 600.

In some embodiments, the linear actuator 24 is an electrically operated lead screw actuator. However, in an alternate embodiment of a traffic warning device (not shown in the drawings), according to the present invention, the linear actuator 24 is a conventional fluid driven linear actuator in the form of an hydraulic or pneumatic cylinder that is connected through fluid conduits to a fluid pump of the vehicle 600 in a known manner. Other types of equivalent linear actuator of the prior art are also usable. Furthermore, the linear actuator 24 is typically sized and configured for allowing the deployable element first and second ends 37 and 49 to be between about 12″ and 58″, for example 24″, laterally away from the vehicle 600 when in the first and second deployed positions.

Furthermore, the operating time required for the deployable element 32 to travel between the parked position and any one of the first and second deployed positions is typically a relatively short period, yet, long enough for allowing a person standing in the way of the travelling member to step aside safely during its operation. For example, the time period may be from about 2 seconds to about 7 seconds. Other operating time periods are also possible.

Referring to FIG. 5, in a specific embodiment of the invention, the controller 40 includes a manually operable, three-position selector 70. The three-position selector 70 is preferably located substantially proximal the position of the driver in the vehicle 600. The three-position selector 70 may be operatively coupled to a first single pole triple-throw selector switch 72 wherein a power source line 74 of the vehicle 600 is connected to the input pole terminal of the switch 72, and a first, second and third position control line 76, 78 and 80 are each individually connected respectively to each one of the three output pole terminals of the switch 72.

By manually operating the three-position selector 70, a contact is selectively established between the power source line 74 and one of the three position control lines 76, 78 or 80 respectively. As is it will be apparent to those skilled in the art, the position control lines 76, 78 and 80 are electrically coupled through the second electrical cable 46 to a suitable drive controller (not shown in the drawings), for example, embedded in the housing of the actuator drive unit 26. The drive controller selectively positions the actuator movable member 28 to the selected parked, first deployed and second deployed position of the deployable element 32 determined by the correspondingly energized position control line 76, 78 or 80 respectively. Thus, in use, the three-position selector 70 may be used by the driver of the vehicle 600 to selectively position the deployable element 32 to its parked, first deployed and second deployed positions.

The vehicle 600 typically includes a motor, drive wheels and a transmission (all not shown in the drawings) provided therebetween, the transmission having power transmitting configurations in which power is transmitted from the motor to the drive wheels and at least one non-power transmitting configuration in which the drive wheels are uncoupled from the motor. When in an operative configuration, the controller 40 is operatively coupled to the transmission so as to prevent activation of the actuator 24 to move the deployable element 32 relative to the base 18 when the transmission is in one of the power transmitting configurations. In some embodiments this is achieved by having the power source line 74 energized by the battery 606 of the vehicle 600 only when the vehicle 600 has its transmission in the park or neutral position through a suitable vehicle contact 608 that is closed in such conditions. Thus, the traffic warning device 10 is operable only when the vehicle 600 has its drive transmission in a park or neutral position.

In some embodiments, the controller 40 is configured for determining when the deployable element 32 is in the parked position, the controller 40 being operatively coupled to the transmission for preventing movement of the transmission from the non-power transmitting configuration to one of the power transmitting configuration unless the deployable element 32 is determined to be in the parked position. This is achieved for example with a controller 40 including a vehicle drive enable contact 82. The vehicle drive enable contact 82 is operatively coupled with the three-position selector 70 through, for example, a second single pole triple-throw switch 84. The second single pole triple-throw switch 84 is configured to allow conductivity in a suitable vehicle circuit 86 that enables a driver to change the drive transmission of the vehicle 600 to a forward or reverse position only when the three-position selector 70 is positioned in the parked position such that the deployable element 32 is substantially centrally positioned relative to the vehicle end portion 602.

As it will be appreciated by those skilled in the art, the controller 40 described above may have any other equivalent electrical configuration without departing from the spirit of the invention. Also, in some embodiments, the controller 40 includes more sophisticated elements, such as microcontrollers or microprocessors, to perform the functionalities described hereinabove.

Referring to FIG. 1, the deployable element 32 is typically provided with at least one, but preferably a plurality of highly visible indicias 88, such as reflectors. In some embodiments, the indicias 88 include light emitting elements 90 that are disposed in a longitudinally spaced apart relationship along the outer surface 35 of the deployable element 32 so as to be visible to incoming traffic. The light emitting elements 90 may include each one or more light emitter, such as light bulbs or Light Emitting Diodes (LEDs) for example.

For example, the light emitting elements 90 are sequentially activated one after the other in a directional sequence towards the associated deployable element first and second end 37 and 39 that is actively extended on one side or the other of the vehicle 600. In other words, the traffic warning device 10 is configured to activate the light emitting elements 90 in a first predetermined sequence when the deployable element 32 is in the deployable element first position and in a second predetermined sequence when the deployable element 32 is in the deployable element 32 second position. In the first predetermined sequence, the light emitting elements 90 are sequentially turned on in a first direction parallel to a first base direction leading from the base second end 21 towards the base first end 19, and, in the second predetermined sequence, the light emitting elements 90 are sequentially turned on in a second direction parallel to a second base direction leading from the base first end 19 towards the base second end 21.

For example, a light controller (not shown in the drawings) suitably positioned within the traffic warning device 10 may be energized through a suitable indicator control line 92 or 94 connected with the second or third control line 78 or 80 respectively, as illustrated in FIG. 5 and activate the light emitting elements 90 as described above. It should be noted that the sequence of activation of the light emitting elements 90 can be any suitable conventional sequence of activation. For example, the light emitting elements 90 can be sequentially turned on for a predetermined duration and then turned off, with only one light emitting element 90 emitting light at any time. In other embodiments, once turned on, the light emitting elements 90 remain turned on until all light emitting elements 90 in a sequence have been turned on, at which point all light emitting elements 90 are turned off after a predetermined delay.

The deployable element 32 may further be provided with a beacon-like indicator 96 such as a stroboscopic light indicator, or the like, adjacent each of the deployable element first and second ends 37 and 39 to further enhance the visibility thereof. In a similar fashion as with the light emitting elements 90, the corresponding beacon-like indicator 96 is activated on the side of the deployable element 32 that protrudes from the vehicle 600.

Preferably, the attachment 12, the base 18 and the deployable element 32 are made of a sufficiently rigid material for substantially absorbing at least a relatively small impact from an incoming vehicle without noticeable damage to the traffic warning device 10 or the vehicle 600. For example, the attachment 12, the base 18 and the deployable element 32 may be made of a suitably rigid and rust proof metal that is substantially equivalent to the metal conventionally use for the manufacture of the shock absorbing bumper elements on vehicles 600.

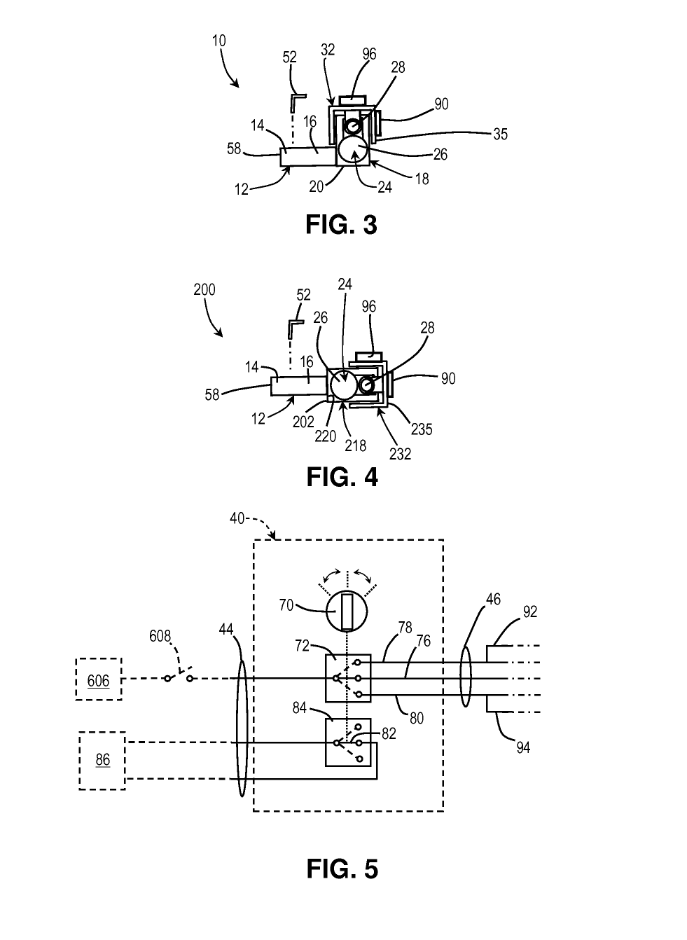

As illustrated in FIGS. 1, 2 and 3, in some embodiments of the invention, the base 18 includes a base main member 20 from which the attachment 12 extends substantially perpendicularly, centered relative thereto. The deployable element 32 has a substantially C-shaped transversal configuration, the base main member 20 being at least partially nested in the deployable element 32. Typically, the base main member 20 and the deployable element are manufactured of a single integrally extending elongated member extending a length that is substantially equal to the width of the vehicle end portion 602. Furthermore, the base main member 20 has a substantially C-shaped transversal configuration. The deployable element 32 has an open ended C-shaped cross-section while the base main member 20 may have open or closed ends. Thus, the actuator drive unit 26 may be conveniently protected from the elements by being attached inside the base main member 20, as illustrated in FIGS. 2 and 3. This is especially the case when the base main member 20 defines substantially opposed base end walls 41 and 43 substantially adjacent the base first and second ends, 37 and 39 so that the base main member 20 and the deployable element 32 together defines an enclosure when the deployable element 32 is in the parked position.

In an alternate embodiment of a traffic warning device 300, as illustrated in FIG. 10, the traffic warning device 300 essentially occupy the position typically occupied by the conventional shock absorbing member, or bumper member, of the vehicle 600. In this present embodiment, the attachment 12 is replaced by at least one screw-and-nut combination 60. The at least one screw-and-nut combination 60 is anchored in the base main member 620 and in a main body frame member 62 of the vehicle 600, substantially proximal the vehicle end portion 602. As can be further observed in FIG. 10, the traffic warning device 200 is attached at the vehicle rear end 604. It is to be understood that the present embodiment of a traffic warning device 200 may be attached to the front end thereof in a similar manner.

In another alternate embodiment of a traffic warning device 200, as illustrated in FIG. 4, the attachment 12 extends laterally distally from a substantially centered portion of the distal longitudinal wall 202 of the C-shaped base main member 220 of the base 218. Thus an outer longitudinal portion 235 of the traffic warning member 232 is facing oppositely distally relative thereof and towards incoming vehicles.

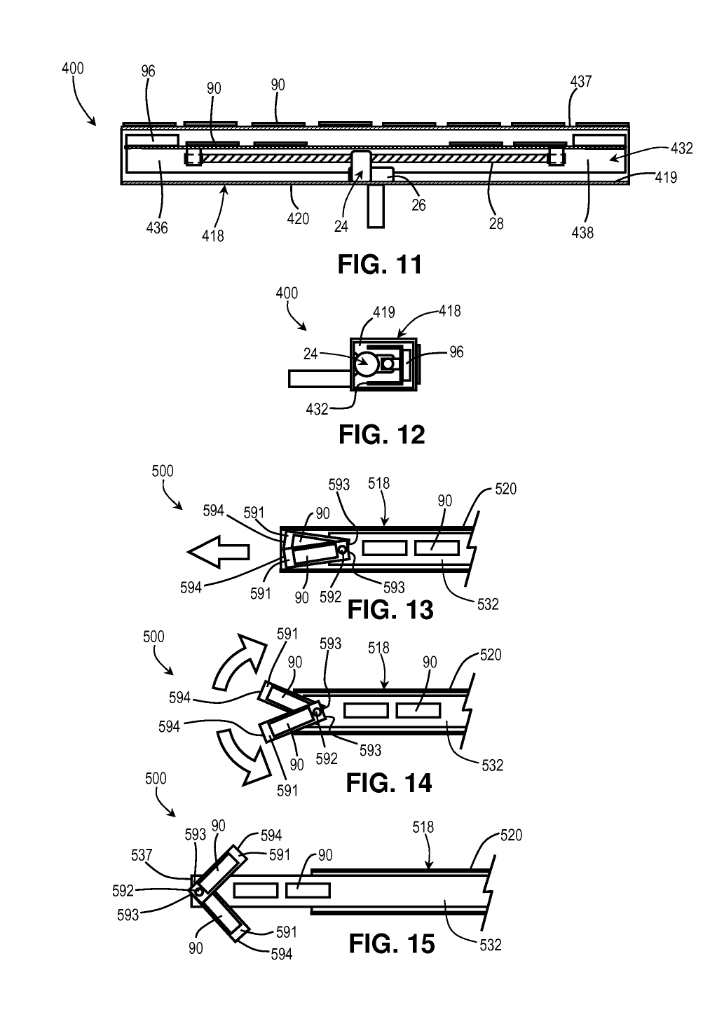

FIGS. 11 and 12 illustrate yet another alternate embodiment of a traffic warning device 400 according to the present invention. This present embodiment is substantially similar to the precedently described embodiment of a traffic warning device 200 except that the base 418 includes a base main member 420 having an open ended tubular configuration defining preferably a substantially square or rectangular cross-section. The base main member 420 thus defines an inner longitudinal passageway 419 therethrough that is shaped and sized for freely slidably engaging therein the C-shaped deployable element 432. The deployable element 432 is therefore at least partially received in the base main member 420. In this particular embodiment, the actuator drive unit 426 is attached to an inner sidewall portion of the tubular base main member 420.

In this particular embodiment, a distal longitudinal wall 437 of the tubular base main member 420 and at least deployable element end portions 436 and 438 are typically covered with a plurality of directional light emitting elements 90 and beacon-like indicators 96 as described further above.

FIGS. 13, 14 and 15 illustrate yet another embodiment of a traffic warning device 500 according to the present invention. This present embodiment is substantially similar to the traffic warning device 400 except that the deployable element 532 is provided with a first and a second pair of wings 591, only one pair if which is shown in the drawings, pivotally mounted to the deployable element 532 substantially adjacent respectively the deployable element first end 537 and the deployable element second end (not shown). The first and second pair of wings 591 are each movable between a retracted configuration, seen in FIG. 13, in which the wings 591 from each of the pair of wings 591 are substantially parallel to the deployable element 532 and an extended configuration, seen in FIG. 15, in which the wings 591 within each of the pair of wings 591 have a substantially V-shaped configuration protruding laterally outwardly from the deployable element 532 and pointing away from the deployable element center location (not shown in FIGS. 13 to 15). FIG. 14 illustrates a semi-retracted configuration intermediate the extended and retracted configurations. Typically, the wings 591 within each pair are pivotally mounted on a common pivot pin 592 at the deployable element first and second ends 537 and not shown.

The wings 591 each define opposed wings proximal and distal ends 593 and 594, the wings pivoting about the pivot pin 592 substantially adjacent the wing proximal ends 593. The wings 591 within each pair of wings 591 are biased towards the extended configuration using a suitable biasing element, which may be integrated with the pivot pins 592. In the parked position, the wings 591 are all at least partially contained in the base main member 520 and confined thereby to the retracted configuration with the wing distal ends 591 further away from the deployable element center location than the pivot pin 592. In the first and second deployed positions, the wings 591 substantially adjacent respectively the deployable element first and second ends 537 and not shown are in the extended configuration.

The wings 591 form an arrow configuration pointing substantially longitudinally distally relative to the deployable element 532 when the latter is in the first or second deployed position, as illustrated in FIG. 15. Furthermore, the deployable element 532 is relatively shorter than the base main member 520 to typically fully conceal the wings 591 in the retracted configuration therein when the deployable element 532 is in the parked position, as illustrated in FIG. 13.

Thus, as each distal end portion of the deployable element 532 protrudes and retracts back inside the tubular base main member 520, the wings 591 are deployed outside of, and alternatively retracted in an inverted configuration within, the distal end of the tubular base main member 520, as sequentially illustrated in FIGS. 13, 14 and 15. In this particular embodiment 500, the wings 591 are typically covered with directional light emitting elements 90 as described further above.

Although the present invention has been described hereinabove by way of exemplary embodiments thereof, it will be readily appreciated that many modifications are possible in the exemplary embodiments without materially departing from the novel teachings and advantages of this invention. Accordingly, the scope of the claims should not be limited by the exemplary embodiments, but should be given the broadest interpretation consistent with the description as a whole. The present invention can thus be modified without departing from the spirit and nature of the subject invention as defined in the appended claims.

What is claimed is:

1. A traffic warning device for a vehicle, said vehicle defining opposite sides, said traffic warning device comprising:
a substantially elongated base defining substantially longitudinally opposed base first and second ends, said base being mounted to said vehicle when said traffic warning device is in an operative configuration; and
a substantially elongated deployable element mounted to said base and movable relative thereto between a parked position, a first deployed position and a second deployed position, wherein, in said parked position, said deployable element extends along said base and is substantially centered relative thereto, in said first deployed position, said deployable element is offset from said base and protrudes therefrom at said base first end, and, in said second deployed position, said deployable element is offset from said base and protrudes therefrom at said base second end;
said deployable element being provided with visible traffic warning elements;
whereby said deployable element is deployable on said opposite sides of said vehicles by being moved respectively to said first and second deployed positions.

2. A traffic warning device as defined in claim 1, wherein said deployable element defines substantially longitudinally opposed deployable element first and second ends, said deployable element first and second ends being respectively substantially adjacent said base first and second ends in said parked position, said deployable element second end being in register with said base in said first deployed position and said deployable element first end being in register with said base in said second deployed position.

3. A traffic warning device as defined in claim 2, further comprising an actuator operatively coupled to said base and to said deployable element for selectively moving said deployable element to said parked, first deployed and second deployed positions and a controller operatively coupled to said actuator for selectively activating said actuator to move said deployable element between said parked, first deployed and second deployed positions.

4. A traffic warning device as defined in claim 3, wherein said actuator is a linear actuator operatively coupled to said base and deployable element for substantially longitudinally moving said base and deployable element relative to each other between said parked, first deployed and second deployed positions.

5. A traffic warning device as defined in claim 3, said vehicle including a motor, drive wheels and a transmission provided therebetween, said transmission having power transmitting configurations in which power is transmitted from said motor to said drive wheels and at least one non-power transmitting configuration in which said drive wheels are uncoupled from said motor, wherein, when in said operative configuration, said controller is operatively coupled to said transmission so as to prevent activation of said actuator to move said deployable element relative to said base when said transmission is in one of said power transmitting configurations.

6. A traffic warning device as defined in claim 5, wherein;
said controller is configured for determining when said deployable element is in said parked position; and
when in said operative configuration, said controller is operatively coupled to said transmission for preventing movement of said transmission from said non-power transmitting configuration to one of said power transmitting configuration unless said deployable element is determined to be in said parked position.

7. A traffic warning device as defined in claim 1, wherein said base includes an attachment removably attachable to said vehicle.

8. A traffic warning device as defined in claim 7, wherein said attachment is attachable to a vehicle towing hitch.

9. A traffic warning device as defined in claim 1, wherein said visible traffic warning elements include light emitting elements.

10. A traffic warning device as defined in claim 9, wherein said light emitting elements are longitudinally spaced apart along said deployable element and said traffic warning device is configured to activate said light emitting elements in a first predetermined sequence when said deployable element is in said deployable element first position and in a second predetermined sequence when said deployable element is in said deployable element second position.

11. A traffic warning device as defined in claim 10, wherein, in said first predetermined sequence, said light emitting elements are sequentially turned on in a first direction parallel to a first base direction leading from said base second end towards said base first end, and, in said second predetermined sequence, said light emitting elements are sequentially turned on in a second direction parallel to a second base direction leading from said base first end towards said base second end.

12. A traffic warning device as defined in claim 1, wherein said base includes a base main member, said deployable element having a substantially C-shaped transversal configuration, said base main member being at least partially nested in said deployable element.

13. A traffic warning device as defined in claim 12, wherein said base main member has a substantially C-shaped transversal configuration, said base main member defining substantially opposed base end walls substantially adjacent said base first and second ends, said base main member and said deployable element together defining an enclosure when said deployable element is in said parked position.

14. A traffic warning device as defined in claim 1, wherein said base includes a base main member, said deployable element being at least partially received in said base main member.

15. A traffic warning device as defined in claim 14, wherein said base main member is substantially tubular.

16. A traffic warning device as defined in claim 14, wherein said deployable element defines substantially longitudinally opposed deployable element first and second ends and a deployable element center location midway therebetween, said deployable element being provided with a first and a second pair of wings pivotally mounted to said deployable element substantially adjacent respectively said deployable element first and second ends, said first and second pair of wings being each movable between a retracted configuration in which said wings from each of said pair of wings are substantially parallel to said deployable element and an extended configuration in which said wings within each of said pair of wings have a substantially V-shaped configuration protruding laterally outwardly from said deployable element and pointing away from said deployable element center location.

17. A traffic warning device as defined in claim 16, wherein
said wings each define opposed wings proximal and distal ends, said wings being pivotally mounted to said deployable element substantially adjacent said wing proximal ends;
said wings within each pair of wings are biased towards said extended configuration;
in said parked position, said wings are all at least partially contained in said base main member and confined thereby to said retracted configuration with said wing distal ends further away from said deployable element center location than said pivot point;
in said first and second deployed positions, said wings substantially adjacent respectively said deployable element first and second ends are in said extended configuration.

18. A vehicle, said vehicle defining opposite sides, said vehicle comprising: a traffic warning device including
a substantially elongated base defining substantially longitudinally opposed base first and second ends, said base being mounted to said vehicle; and
a substantially elongated deployable element mounted to said base and movable relative thereto between a parked position, a first deployed position and a second deployed position, wherein, in said parked position, said deployable element extends along said base and is substantially centered relative thereto, in said first deployed position, said deployable element is offset from said base and protrudes therefrom at said base first end, and, in said second deployed position, said deployable element is offset from said base and protrudes therefrom at said base second end;
said deployable element being provided with visible traffic warning elements;
whereby said deployable element is deployable on said opposite sides of said vehicles by being moved respectively to said first and second deployed positions.
